(19) United States
(12) Patent Application Publication
(10) Pub. No.: US 2003/0035573 A1
(43) Pub. Date: Feb. 20, 2003

(54) Method for learning-based object detection in cardiac magnetic resonance images

(76) Inventors: Nicolae Duta, Medford, MA (US); Marie-Pierre Jolly, Hillsborough, NJ (US)

Correspondence Address: Siemens Corporation, Intellectual Property Department, 186 Wood Avenue South, Iselin, NJ, 08830, US

(21) Appl. No.: 09/741,580

(22) Filed: Dec. 20, 2000

Related U.S. Application Data
(60) Provisional application No. 60/171,423, filed on Dec. 22, 1999.

(51) Int. Cl. G06K 9/00

(52) U.S. Cl. 382/128

(57) ABSTRACT

An automated method for detection of an object of interest in magnetic resonance (MR) two-dimensional (2-D) images wherein the images comprise gray level patterns, the method includes a learning stage utilizing a set of positive/negative training samples drawn from a specified feature space. The learning stage comprises the steps of estimating the distributions of two probabilities P and N are introduced over the feature space, P being associated with positive samples including said object of interest and N being associated with negative samples not including said object of interest; estimating parameters of Markov chains associated with all possible site permutations using said training samples; computing the best site ordering that maximizes the Kullback distance between P and N; computing and storing the log-likelihood ratios induced by said site ordering; scanning a test image at different scales with a constant size window; deriving a feature vector from results of said scanning; and classifying said feature vector based on said best site ordering.

Reference is hereby made to provisional patent application Application No. 60/171,423 filed Dec. 22, 1999 in the names of Duta and Jolly, and whereof the disclosure is hereby incorporated herein by reference.

The present invention relates generally to detecting flexible objects in gray level images and, more specifically, to an automated method for left ventricle detection in magnetic resonance (MR) cardiac images.

In one aspect, an object of the present invention is concerned with detecting the left ventricle in short axis cardiac MR images. There has been a substantial amount of recent work in studying the dynamic behavior of the human heart using non-invasive techniques such as magnetic resonance imaging (MRI). See for example, D. Geiger, A. Gupta, L. Costa, and J. Vlontzos, Dynamic programming for detecting, tracking, and matching deformable contours, IEEE Trans. Pattern Analysis and Machine Intelligence, 17(3):294-302, 1995; and J. Weng, A. Singh, and M. Y. Chiu. Learning-based ventricle detection form cardiac MR and CT images, IEEE Trans. Medical Imaging, 16(4):378-391, 1997.

In order to provide useful diagnostic information, it is herein recognized that a cardiac imaging system should perform several tasks such as segmentation of heart chambers, identification of the endocardium and epicardium, measurement of the ventricular volume over different stages of the cardiac cycle, measurement of the ventricular wall motion, and so forth. Most prior art approaches to segmentation and tracking of heart ventricles are based on deformable templates, which require specification of a good initial position of the boundary of interest. This is often provided manually, which is time consuming and requires a trained operator.

Another object of the present invention is to automatically learn the appearance of flexible objects in gray level images. A working definition of appearance, used herein in accordance with the invention, is that it is the pattern of gray values in the object of interest and its immediate neighborhood. The learned appearance model can be used for object detection: given an arbitrary gray level image, decide if the object is present in the image and find its location(s) and size(s). Object detection is typically the first step in a fully automatic segmentation system for applications such as medical image analysis (see, for example, L. H. Staib and J. S. Duncan. Boundary finding with parametrically deformable models. IEEE Trans. Pattern Analysis and Machine Intelligence, 14(11):1061-1075m 1992; N. Ayache, I. Cohen, and I. Herlin. Medical image tracking. In Active Vision, A. Blake and A. Yuille (eds.), 1992. MIT Press; T. McInerney and D. Terzopoulos. Deformable models in medical image analysis: A survey. Medical Image Analysis, 1(2):91-108, 1996; and such as industrial inspection, surveillance systems and human-computer interfaces.

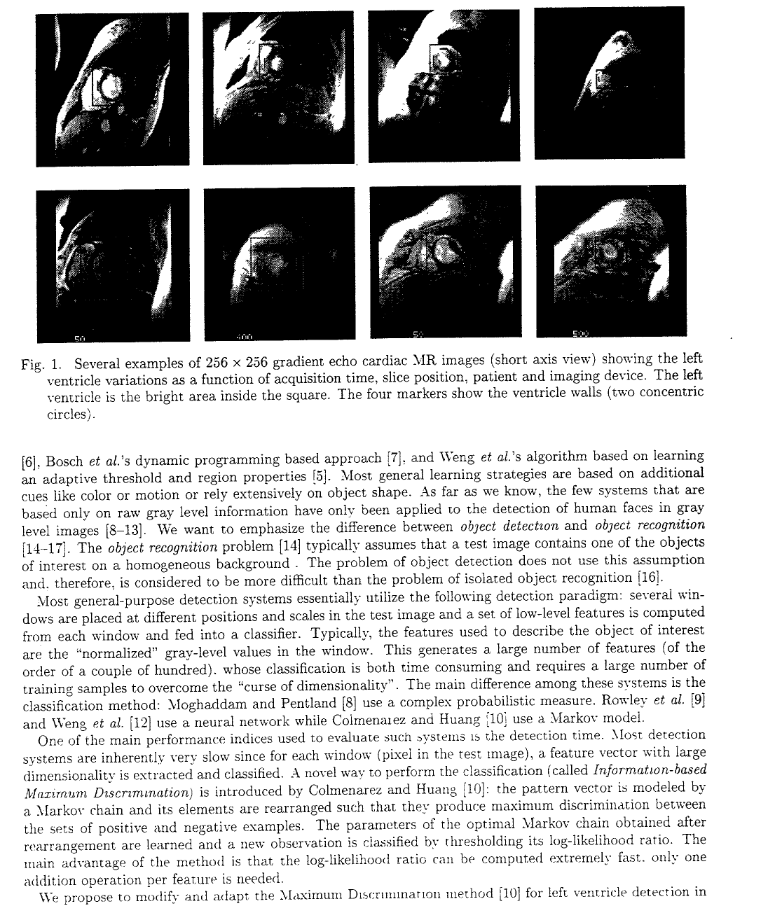

Another object of the present invention is to automatically provide the approximate scale/position, given by a tight bounding box, of the left ventricle in two-dimensional (2-D) cardiac MR images. This information is needed by most deformable template segmentation algorithms which require that a region of interest be provided by the user. This detection problem is difficult because of the variations in shape, scale, position and gray level appearance exhibited by the cardiac images across different slice positions, time instants, patients and imaging devices. See FIG. 1, which shows several examples of 256×256 gradient echo cardiac MR images (short axis view) showing the left ventricle variations as a function of acquisition time, slice position, patient and imaging device. The left ventricle is the bright area inside the square. The four markers show the ventricle walls (two concentric circles).

In accordance with another aspect of the invention, an automated method for detection of an object of interest in magnetic resonance (MR) two-dimensional (2-D) images wherein the images comprise gray level patterns, the method includes a learning stage utilizing a set of positive/negative training samples drawn from a specified feature space. The learning stage comprises the steps of estimating the distributions of two probabilities P and N introduced over the feature space, P being associated with positive samples including said object of interest and N being associated with negative samples not including said object of interest; estimating parameters of Markov chains associated with all possible site permutations using said training samples; computing the best site ordering that maximizes the Kullback distance between P and N; computing and storing the log-likelihood ratios induced by said site ordering; scanning a test image at different scales with a constant size window; deriving a feature vector from results of said scanning; and classifying said feature vector based on said best site ordering.

The invention will be more fully understood from the detailed description of preferred embodiments which follows in conjunction with the drawing, in which

FIG. 1 shows examples of 256×256 gradient echo cardiac MR images;

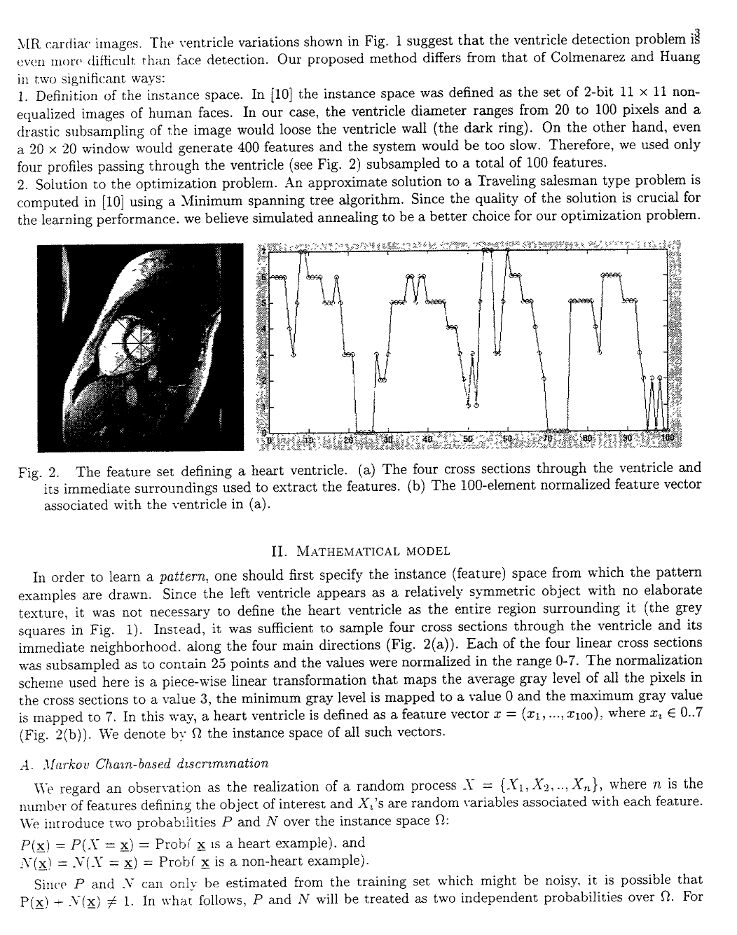

FIG. 2 shows the feature set defining a heart ventricle;

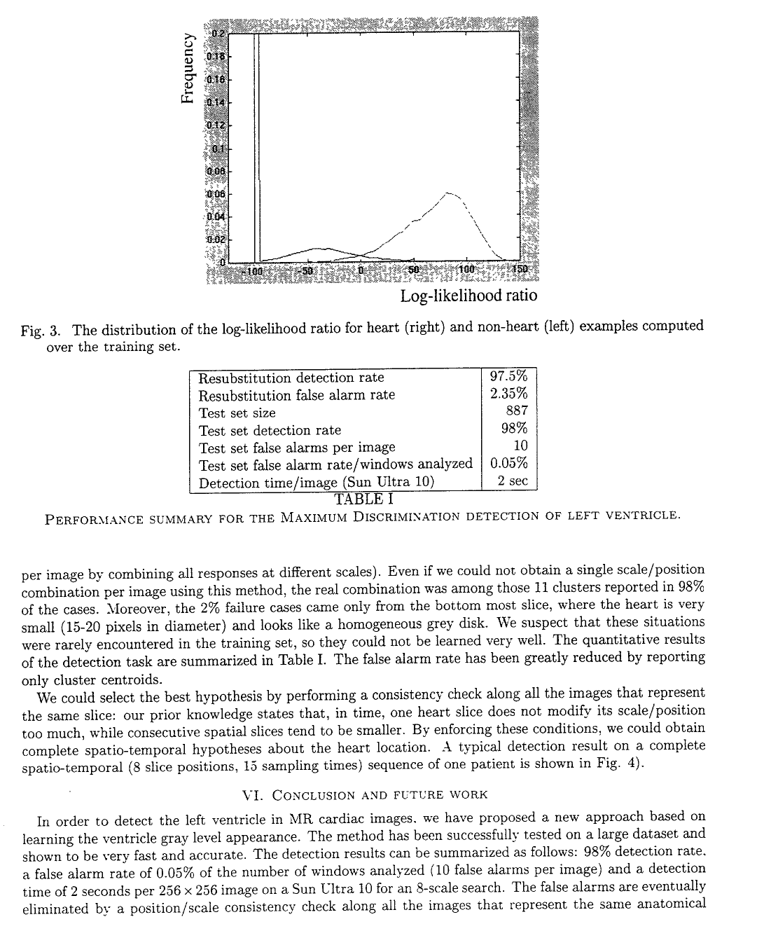

FIG. 3 shows the distribution of the log-likelihood ratio for heart (right) and non-heart (left); and

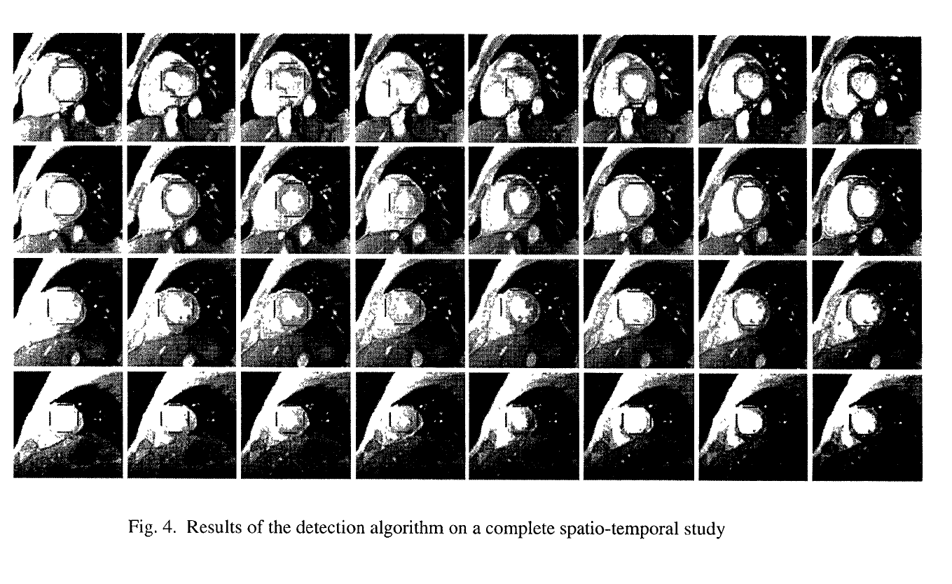

FIG. 4 shows results of the detection algorithm on a complete spatio-temporal study

Ventricle detection is the first step in a fully automated segmentation system used to compute volumetric information about the heart. In one aspect, the method in accordance with the present invention comprises learning the gray level appearance of the ventricle by maximizing the discrimination between positive and negative examples in a training set. The main differences from previously reported methods are feature definition and solution to the optimization problem involved in the learning process. By way of a non-limiting example, in a preferred embodiment in accordance with the present invention, training was carried out on a set of 1,350 MR cardiac images from which 101,250 positive examples and 123,096 negative examples were generated. The detection results on a test set of 887 different images demonstrate a high performance: 98% detection rate, a false alarm rate of 0.05% of the number of windows analyzed (10 false alarms per image) and a detection time of 2 seconds per 256×256 image on a Sun Ultra 10 for an 8-scale search. The false alarms are eventually eliminated by a position/scale consistency check along all the images that represent the same anatomical slice.

In the description in the present application, a distinction is made between the algorithms designed to detect specific structures in medical images and general methods that can be trained to detect an arbitrary object in gray level images. The dedicated detection algorithms rely on the designer's knowledge about the structure of interest and its variation in the images to be processed, as well as on the designer's ability to code this knowledge. On the other hand, a general detection method requires very little, if any, prior knowledge about the object of interest.

The specific domain information is usually replaced by a general learning mechanism based on a number of training examples of the object of interest. Examples of using domain specific methods for ventricle detection in cardiac images include, for example, Chiu and Razi's mutiresolution approach for segmenting echocardiograms, see C. H. Chiu and D. H. Razi. A nonlinear multiresolution approach to echocardiographic image segmentation. Computers in Cardiology, pages 431-434, 1991; Bosch et al.'s dynamic programming based approach, see J. G. Bosch, J. H. C. Reiber, G. Burken, J. J. Gerbrands, A. Kostov, A. J. van de Goor, M. Daele, and J. Roelander. Developments towards real time frame-to-frame automatic contour detection from echocardiograms. Computers in Cardiology, pages 435-438, 1991; and Weng et al.'s algorithm based on learning an adaptive threshold and region properties, see the afore-mentioned paper by Weng et al.

General learning strategies are typically based on additional cues such as color or motion or they rely extensively on object shape. Insofar as the inventors are aware, the few systems that are based only on raw gray level information have only been applied to the detection of human faces in gray level images.

See, for example the following papers: B. Moghaddam and A. Pentland. Probabilistic visual learning for object representation. IEEE Trans. Pattern Analysis and Machine Intelligence, 19(7):696-710, 1997; H. Rowley, S. Baluja, and T. Kanade. Neural network-based face detection. IEEE Trans. Pattern Analysis and Machine Intelligence, 20(1):23-38, 1998; A. Colmenarez and T. Huang. Face detection with information-based maximum discrimination. In Proc. IEEE Conf. Computer Vision and Pattern Recognition, San-Juan, Puerto Rico, 1997; Y. Amit, D. Geman, and K. Wilder. Joint induction of shape features and tree classifiers. IEEE Trans. Pattern Analysis and Machine Intelligence, 19:1300-1306, 1997; J. Weng, N. Ahuja, and T. S. Huang. Learning, recognition and segmentation using the Cresceptron. International Journal of Computer Vision, 25:105-139, 1997; and A. L. Ratan, W. E. L. Grimson, and W. M. Wells. Object detection and localization by dynamic template warping. In IEEE Conf Computer Vision and Pattern Recognition, pages 634-640, Santa Barbara, Calif., 1998.

It is herein recognized that it is desirable to emphasize the difference between object detection and object recognition. See, for example, S. K. Nayar, H. Murase, and S. Nene. Parametric appearance representation. In Early Visual Learning, pages 131-160, S. K. Nayar and T. Poggio (eds.), 1996. Oxford University Press; S. K. Nayar and T. Poggio (eds.). Early Visual Learning. Oxford University Press, Oxford, 1996; T. Poggio and D. Beymer. Regularization networks for visual learning. In Early Visual Learning, pages 43-66, S. K. Nayar and T. Poggio (eds.), 1996. Oxford University Press; and J. Peng and B. Bahnu. Closed-loop object recognition using reinforcement learning. IEEE Trans. Pattern Analysis and Machine Intelligence, 20(2):139-154, 1998.

The object recognition problem, (see the afore-mentioned paper by S. K. Nayar, H. Murase, and S. Nene), typically assumes that a test image contains one of the objects of interest on a homogeneous background. The problem of object detection does not use this assumption and, therefore, is generally considered to be more difficult than the problem of isolated object recognition. See the afore-mentioned paper by T. Poggio and D. Beymer].

Typical prior art general-purpose detection systems essentially utilize the following detection paradigm: several windows are placed at different positions and scales in the test image and a set of low-level features is computed from each window and fed into a classifier. Typically, the features used to describe the object of interest are the “normalized” gray-level values in the window. This generates a large number of features (of the order of a couple of hundred), whose classification is both time-consuming and requires a large number of training samples to overcome the “curse of dimensionality”. The main difference among these systems is the classification method: With reference to their afore-mentioned paper, Moghaddam and Pentland use a complex probabilistic measure, as disclosed in the afore-mentioned paper by Rowley et al. and the afore-mentioned paper by J. Weng, N. Ahuja, and T. S. Huang, use a neural network while Colmenarez and Huang use a Markov model. See the afore-mentioned paper by Colmenarez and Huang.

One of the main performance indices used to evaluate such systems is the detection time. Most detection systems are inherently very slow since for each window (pixel in the test image), a feature vector with large dimensionality is extracted and classified. A way to perform the classification, called Information-based Maximum Discrimination, is disclosed by Colmenarez and Huang in their aforementioned paper: the pattern vector is modeled by a Markov chain and its elements are rearranged such that they produce maximum discrimination between the sets of positive and negative examples. The parameters of the optimal Markov chain obtained after rearrangement are learned and a new observation is classified by thresholding its log-likelihood ratio. The main advantage of the method is that the log-likelihood ratio can be computed extremely fast, only one addition operation per feature being needed.

In accordance with an aspect of the invention, certain principles relating to information-based maximum discrimination are adapted and applied in a modified sense to the problem of left ventricle detection in MR cardiac images. It is herein recognized that the ventricle variations shown in FIG. 1 suggest that the ventricle detection problem is even more difficult than face detection.

An aspect of the present invention relates to the definition of the instance space. In the afore-mentioned paper by A. Colmenarez and T. Huang, the instance space was defined as the set of 2-bit 11×11 non-equalized images of human faces. In accordance with an aspect of the present invention, the ventricle diameter ranges from 20 to 100 pixels and a drastic subsampling of the image would lose the ventricle wall (the dark ring). On the other hand, even a 20×20 window would generate 400 features and the system would be too slow. Therefore, an embodiment of the present invention utilizes only four profiles passing through the ventricle subsampled to a total of 100 features. See FIG. 2, which shows the feature set defining a heart ventricle. (a) The four cross sections through the ventricle and its immediate surroundings used to extract the features. (b) The 100-element normalized feature vector associated with the ventricle in (a).

Another aspect of the present invention relates to the solution to the optimization problem. An approximate solution to a Traveling salesman type problem is computed in the aforementioned paper by Colmenarez and T. Huang using a Minimum spanning tree algorithm. It is herein recognized that the quality of the solution is crucial for the learning performance and that simulated annealing is a better choice for the present optimization problem.

The mathematical model will next be considered. In order to learn a pattern, one should first specify the instance (feature) space from which the pattern examples are drawn. Since the left ventricle appears as a relatively symmetric object with no elaborate texture, it was not necessary to define the heart ventricle as the entire region surrounding it (the grey squares in FIG. 1). Instead, it was sufficient to sample four cross sections through the ventricle and its immediate neighborhood, along the four main directions (FIG. 2(a)). Each of the four linear cross sections was subsampled so as to contain 25 points and the values were normalized in the range 0-7. The normalization scheme used here is a piece-wise linear transformation that maps the average gray level of all the pixels in the cross sections to a value 3, the minimum gray level is mapped to a value 0 and the maximum gray value is mapped to 7. In this way, a heart ventricle is defined as a feature vector x=(x₁, . . . ,x₁₀₀), where xᵢ ε0 . . . 7 (FIG. 2(b)). We denote by Ω the instance space of all such vectors.

In the following a Markov chain-based discrimination is considered. An observation is herein regarded as the realization of a random process X={X₁,X₂, . . . ,Xₙ}, where n is the number of features defining the object of interest and Xᵢ's are random variables associated with each feature. Two probabilities P and N are introduced over the instance space Ω:

P(x)=P(X=x)=Prob(x is a heart example)

N(x)=N(X=x)=Prob(x is a non heart example).

Since P and N can only be estimated from the training set which might be noisy, it is possible that P(x)+N(x)≠1. In what follows, P and N will be treated as two independent probabilities over Ω. For each instance xεΩ, we define its log-likelihood ratio

$$L ( \underline{x} ) = log \frac{P ( \underline{x} )}{N ( \underline{x} )} .$$

Note that L(x)>0 if and only if x is more probable to be a heart than a non-heart, while L(x)<0 if the converse is true.

The Kullback divergence between P and N can be regarded as the average of the log-likelihood ratio over the entire instance space. See R. M. Gray. Entropy and Information Theory. Springer-Verlag, Berlin, 1990.

$${H}_{P ‖ N} = {\sum }_{\underline{x} ε Ω} P ( \underline{x} ) log \frac{P ( \underline{x} )}{N ( \underline{x} )} \qquad ( 1 )$$

It has been shown that the Kullback divergence is not a distance metric. However, it is generally assumed that the larger H_{P∥N} is, the better one can discriminate between observations from the two classes whose distributions are P and N. It is not computationally feasible to estimate P and N taking into account all the dependencies between the features. On the other hand, assuming a complete independence of the features is not realistic because of the mismatch between the model and the data. A compromise is to consider the random process X to be a Markov chain, which can model the dependency in the data with a reasonable amount of computation.

Let us denote by S the set of feature sites with an arbitrary ordering {s₁,s₂, . . . ,sₙ} of sites {1, 2, . . . ,n}. Denote by X_{S}={Xₛ_{₁}, . . . ,Xₛ_{ₙ}} an ordering of the random variables that compose X corresponding to the site ordering {s₁,s₂, . . . ,sₙ}. If X_{S} is considered to be a first-order Markov chain then for x=(x₁,x₂, . . . ,xₙ)εΩ one has:

P(X_{S}=x)=P(Xₛ_{₁}=x₁, . . . , Xₛ_{ₙ}=xₙ)

=P(Xₛ_{ₙ}=xₙ|Xₛ_{ₙ₋₁}=xₙ₋₁)× . . . ×P(Xₛ_{₂}=x₂|Xₛ_{₁}=X₁)×P(Xₛ_{₁}=x₁)

Therefore, the log-likelihood ratio of the two distributions P and N under the Markov chain assumption can be written as follows:

$$\begin{matrix}{L}^{S} ( \underline{x} ) = log \frac{P ( {X}_{S} = \underline{x} )}{N ( {X}_{S} = \underline{x} )} \\ = log ( \frac{P ( {X}_{{S}_{1}} = {x}_{1} )}{N ( {X}_{{S}_{1}} = {x}_{1} )} {\prod }_{i = 2}^{n} \frac{P ( {X}_{{S}_{1}} = {x}_{i} \vert {X}_{{S}_{i - 1}} = {x}_{i - 1} )}{N ( {X}_{{S}_{1}} = {x}_{i} \vert {X}_{{S}_{i - 1}} = {x}_{i - 1} )} ) \\ = {\sum }_{i = 2}^{n} log \frac{P ( {X}_{{S}_{i}} = {x}_{i} \vert {X}_{{S}_{i - 1}} = {x}_{i - 1} )}{N ( {X}_{{S}_{i}} = {x}_{i} \vert {X}_{{S}_{i - 1}} = {x}_{i - 1} )} + log \frac{P ( {X}_{{S}_{1}} = {x}_{1} )}{N ( {X}_{{S}_{1}} = {x}_{1} )} \\ = {L}^{{S}_{1}} ( {x}_{1} ) + {\sum }_{i = 2}^{n} {L}^{{S}_{1} ‖ {s}_{i - 1}} ( {x}_{1} , {x}_{i - 1} )\end{matrix} \qquad ( 2 )$$

The Kullback divergence of the two distributions P and N under the Markov chain assumption can be computed as follows:

$$\begin{matrix}{H}_{P ‖ N}^{S} = {H}_{P ‖ N} ( {X}_{{S}_{1}} , … , {X}_{{S}_{n}} ) \\ = {\sum }_{( {x}_{1} , … , {x}_{n} ) ∈ Ω} P ( {X}_{{S}_{1}} = {x}_{1} , … , {X}_{{S}_{n}} = {x}_{n} ) log \frac{P ( {X}_{{S}_{1}} = {x}_{1} , … , {X}_{{S}_{n}} = {x}_{n} )}{N ( {X}_{{S}_{1}} = {x}_{1} , … , {X}_{{S}_{n}} = {x}_{n} )} \\ = {\sum }_{( {x}_{1} , … , {x}_{n} ) ∈ Ω} P ( {X}_{{S}_{1}} = {x}_{1} , … , {X}_{{S}_{n}} = {x}_{n} ) log ( \frac{P ( {X}_{{S}_{1}} = {x}_{1} )}{N ( {X}_{{S}_{1}} = {x}_{1} )} {\prod }_{i = 2}^{n} \frac{P ( {X}_{{S}_{1}} = {x}_{i} \vert {X}_{{S}_{i - 1}} = {x}_{i - 1} )}{N ( {X}_{{S}_{i}} = {x}_{i} \vert {X}_{{S}_{i - 1}} = {x}_{i - 1} )} ) \\ = {\sum }_{i = 2}^{n} {\sum }_{( {x}_{1} , … , {x}_{n} ) ∈ Ω} P ( {X}_{{S}_{1}} = {x}_{1} , … , {X}_{{S}_{n}} = {x}_{n} ) log \frac{P ( {X}_{{S}_{i}} = {x}_{i} \vert {X}_{{S}_{i - 1}} = {x}_{i - 1} )}{N ( {X}_{{S}_{i}} = {x}_{i} \vert {X}_{{S}_{i - 1}} = {x}_{i - 1} )} + \\ {\sum }_{( {x}_{1} , … , {x}_{n} ) ∈ Ω} P ( {X}_{{S}_{1}} = {x}_{1} , … , {X}_{{S}_{n}} = {x}_{n} ) log \frac{P ( {X}_{{S}_{1}} = {x}_{1} )}{N ( {X}_{{S}_{1}} = {x}_{1} )} \\ = {\sum }_{i = 2}^{n} ( {\sum }_{( {x}_{i} , {x}_{i - 1} )} P ( {X}_{{S}_{1}} = {x}_{i} , {X}_{{S}_{i - 1}} = {x}_{i} ) log \frac{P ( {X}_{{S}_{1}} = {x}_{i} \vert {X}_{{S}_{i - 1}} = {x}_{i - 1} )}{N ( {X}_{{S}_{1}} = {x}_{i} \vert {X}_{{S}_{i - 1}} = {x}_{i - 1} )} + \sum P ( {X}_{{S}_{1}} = {x}_{1} ) log \frac{P ( {X}_{{S}_{1}} = {x}_{1} )}{N ( {X}_{{S}_{1}} = {x}_{1} )} ) \\ = {H}_{P ‖ N} ( {X}_{1} ) + {\sum }_{i = 2}^{n} {H}_{P ‖ N} ( {X}_{i} ‖ {X}_{i - 1} )\end{matrix} \qquad ( 3 )$$

Next consider the most discriminant Markov chain. One can note that the divergence H_{P∥N}^{S} defined in Eq. (3) depends on the site ordering {s₁,s₂, . . . ,sₙ} because each ordering produces a different Markov chain with a different distribution. The goal of the learning procedure is to find a site ordering S* that maximizes H_{P∥N}^{S} which will result in the best discrimination between the two classes. The resulting optimization problem, although related to Traveling salesman problem, is more difficult than the Traveling salesman problem since:

1. It is asymmetric (the conditional Kullback divergence is not symmetric, i.e. H_{P∥N}(Xᵢ∥Xᵢ₋₁)≠H_{P∥N}(Xᵢ₋₁∥Xᵢ)).

2. The salesman does not complete the tour, but remains in the last town.

3. The salesman starts from the first town with a handicap (H_{P∥N}(X₁)) which depends only on the starting point.

Therefore, the instance space of this problem is of the order of n×n!, where n is the number of towns (feature sites), since for each town permutation one has n starting possibilities. It is well known that this type of problem is NP-complete and cannot be solved by brute-force except for a very small number of sites. Although for the symmetric Traveling salesman problem there exist strategies to find both exact and approximate solutions in a reasonable amount of time, we are not aware of any heuristic for solving the asymmetric problem involved here. However, a good approximative solution can be obtained using simulated annealing. See, for example, E. Aarts and J. Korst. Simulated Annealing and Boltzmann Machines: A Stochastic Approach to Combinatorial Optimization and Neural Computing. Wiley, Chichester, 1989.

Even though there is no theoretical guarantee to find an optimal solution, in practice, simulated annealing does find almost all the time a solution which is very close to the optimum (see also the discussion in the aforementioned paper by E. Aarts and J. Korst.

Comparing the results produced by the simulated annealing algorithm on a large number of trials with the optimal solutions (for small size problems), it has been found by the present inventors that all the solutions produced by simulated annealing were within 5% of the optimal solutions.

Once S* is found, one can compute and store tables with the log-likelihood ratios such that, given a new observation, its log-likelihood can be obtained from n−1 additions using Eq.(2).

The learning stage, which is described in Algorithm 1, starts by estimating the distributions P and N and the parameters of the Markov chains associated with all possible site permutations using the available training examples. Next, the site ordering that maximizes the Kullback distance between P and N is found, and the log-likelihood ratios induced by this ordering are computed and stored.

Algorithm 1: Finding the Most Discriminating Markov Chain

Given a set of positive/negative training examples (as preprocessed n-feature vectors).

1. For each feature site sᵢ, estimate P(Xₛᵢ=v) and N(Xₛᵢ=v) for vε{0 . . . GL-1} (GL=number of gray levels) and compute the divergence H_{P∥N}(Xₛᵢ).

2. For each site pair (sᵢ,sⱼ), estimate P(Xₛᵢ=v₁,Xₛⱼ=v₂), N(Xₛᵢ=v₁,Xₛⱼ=v₂), P(Xₛᵢ=v₁|Xₛⱼ=v₂), and N(Xₛᵢ=v₁|Xₛⱼ=v₂), for v₁,v₂ε{0 . . . GL-1} and compute

$${H}_{P ‖ N} ( {X}_{{S}_{i}} ‖ {X}_{{S}_{j}} ) = {\sum }_{x , y = 0}^{GL - 1} {P}_{X} ( X = x , Y = y ) ln \frac{{P}_{X} ( X = x \vert Y = y )}{{N}_{X} ( X = x \vert Y = y )}$$

3. Solve a traveling salesman type problem over the sites S to find S*={s₁*, . . . , sₙ*} that maximizes H_{P∥N}(X_{S}).

4. Compute and store

$$L ( {X}_{{s}_{1}^{*}} = v ) = ln \frac{P ( {X}_{{s}_{1}^{*}} = v )}{N ( {X}_{{s}_{1}^{*}} = v )} and L ( {X}_{{s}_{1}^{*}} = {v}_{1} ‖ {X}_{{s}_{i - 1}^{*}} = {v}_{2} ) = ln \frac{P ( {X}_{{S}_{1}^{*}} = {v}_{1} ‖ {X}_{{s}_{i - 1}^{*}} = {v}_{2} )}{N ( {X}_{{s}_{i}}^{*} = {v}_{1} ‖ {X}_{{s}_{i - 1}}^{*} = {v}_{2} )}$$

for v,v₁,v₂ε{0 . . . GL-1}.

Next, consider the classification procedure. The detection (testing) stage comprises scanning the test image at different scales with a constant size window from which a feature vector is extracted and classified. The classification procedure using the most discriminant Markov chain, detailed in Algorithm 2, is very simple: the log-likelihood ratio for that window is computed as a sum of conditional log-likelihood ratios associated with the Markov chain ordering (Eq. (2)). The total number of additions used is at most equal to the number of features.

Algorithm 2: Classification

Given S*, the best Markov chain structure and the learned likelihoods L(Xₛ₁*=v) and L(Xₛᵢ*=v₁∥Xₛᵢ₋₁*=v₂).

Given a test example O=(o₁. . . , oₙ) (as preprocessed n-feature vector).

1. Compute the likelihood

$${L}_{o} = L ( {X}_{{s}_{i}^{*}} = {o}_{{s}_{i}^{*}} ) + {\sum }_{i = 2}^{n} L ( {X}_{{s}_{i}^{*}} = {o}_{{s}_{i}^{*}} ‖ {X}_{{s}_{i - 1}^{*}} = {o}_{{s}_{i - 1}^{*}} )$$

2. If Lₒ>T then classify O as heart else classify it as nonheart.

Here T is a threshold to be learned from the ROC curve of the training set depending on the desired (correct detect—false alarm) trade-off. In order to make the classification procedure faster, one can skip from the likelihood computation the terms with little discriminating power (associated Kullback distance is small).

Experimental results are next described, first with regard to the training data. A collection of 1,350 MR cardiac images from 14 patients was used to generate positive training examples. The images were acquired using a Siemens Magnetom MRI system. For each patient, a number of slices (4 to 10) were acquired at different time instances (5 to 15) of the heart beat, thus producing a matrix of 2D images (in FIG. 4, slices are shown vertically and time instances are shown horizontally). As the heart is beating, the left ventricle is changing its size, but the scale factor between end diastolic and end systolic periods is negligible compared to the scale factor between slices at the base and the apex of the heart.

On each image, a tight bounding box (defined by the center coordinates and scale) containing the left ventricle was manually identified. From each cardiac image, 75 positive examples were produced by translating the manually defined box up to 2 pixels in each coordinate and scaling it up or down 10%. In this way, a total of 101,250 positive examples were generated. We also produced a total of 123,096 negative examples by uniformly subsampling a subset of the 1,350 available images at 8 different scales. The distributions of the log-likelihood values for the sets of positive and negative examples are shown in FIG. 3 which shows the distribution of the log-likelihood ratio for heart (right) and non-heart (left) examples computed over the training set. They are very well separated, and by setting the decision threshold at 0, the resubstitution detection rate is 97.5% with a false alarm rate of 2.35%.

Next, the test data will be discussed. The present algorithm was tested on a dataset of 887 images (size 256×256) from 7 patients different from those used for training. Each image was subsampled at 8 different scales and scanned with a constant 25×25 pixel window using a step of 2 pixels in each direction. This means that, at each scale, a number of windows equal to a quarter of the number of pixels of the image at that scale was used for feature extraction and classification. All positions that produced a positive log-likelihood ratio were classified as hearts. Since several neighboring positions might have been classified as such, we partitioned them into clusters (a cluster was considered to be a set of image positions classified as hearts that had a distance smaller than 25 pixels to its centroid). At each scale, only the cluster centroids were reported, together with the log-likelihood ratio value for that cluster (a weighted average of the log-likelihood ratio values in the cluster).

It was not possible to choose the best scale/position combination based on the log-likelihood value of a cluster. That is, values of the log-likelihood criterion obtained at different scales are not comparable: in about 25% of the cases, the largest log-likelihood value failed to represent the real scale/position combination. Accordingly, all cluster positions generated at different scales are reported (an average of 11 clusters are generated per image by combining all responses at different scales). Even if we could not obtain a single scale/position combination per image using this method, the real combination was among those 11 clusters reported in 98% of the cases. Moreover, the 2% failure cases came only from the bottom-most slice, where the heart is very small (15-20 pixels in diameter) and looks like a homogeneous grey disk. It is believed that these situations were rarely encountered in the training set, so they could not be learned very well. The quantitative results of the detection task are summarized in Table 1. The false alarm rate has been greatly reduced by reporting only cluster centroids.

The best hypothesis could be selected by performing a consistency check along all the images that represent the same slice: our prior knowledge states that, in time, one heart slice does not modify its scale/position too much, while consecutive spatial slices tend to be smaller. By enforcing these conditions, we could obtain complete spatio-temporal hypotheses about the heart location. A typical detection result on a complete spatio-temporal (8 slice positions, 15 sampling times) sequence of one patient is shown in FIG. 4 which shows results of the detection algorithm on a complete spatio-temporal study.

TABLE 1
Performance summary for the Maximum
Discrimination detection of left ventricle.

| | |
|---|---|
| Resubstitution detection rate | 97.5% |
| Resubstitution false alarm rate | 2.35% |
| Test set size | 887 |
| Test set detection rate | 98% |
| Test set false alarms per image | 10 |
| Test set false alarm rate/windows analyzed | 0.05% |
| Detection time/image (Sun Ultra 10) | 2 sec |

The method of the present invention represents a new approach for detecting the left ventricle in MR cardiac images, based on learning the ventricle gray level appearance. The method has been successfully tested on a large dataset and shown to be very fast and accurate. The detection results can be summarized as follows: 98% detection rate, a false alarm rate of 0.05% of the number of windows analyzed (10 false alarms per image) and a detection time of 2 seconds per 256×256 image on a Sun Ultra 10 for an 8-scale search. The false alarms are eventually eliminated by a position/scale consistency check along all the images that represent the same anatomical slice. A commercial product from Siemens (Argus) offers an automatic segmentation feature to extract the left ventricle in cardiac MR images using deformable templates. See the aforementioned paper by Geiger et al. The segmentation results are then used to compute volumetric information about the heart.

While the method has been described by way of exemplary embodiments, it will be understood by one of skill in the art to which it pertains that various changes and modifications may be made without departing from the spirit of the invention which is defined by the scope of the claims following.

What is claimed is:

1. An automated method for detection of an object of interest in magnetic resonance (MR) two-dimensional (2-D) images wherein said images comprise gray level patterns, said method including a learning stage utilizing a set of positive/negative training samples drawn from a specified feature space, said learning stage comprising the steps of:
estimating the distributions of two probabilities P and N are introduced over the feature space, P being associated with positive samples including said object of interest and N being associated with negative samples not including said object of interest;
estimating parameters of Markov chains associated with all possible site permutations using said training samples;
computing the best site ordering that maximizes the Kullback distance between P and N using simulated annealing;
computing and storing the log-likelihood ratios induced by said site ordering;
scanning a test image at different scales with a constant size window;
deriving a feature vector from results of said scanning; and
classifying said feature vector based on said best site ordering.

2. An automated method for detection of an object of interest in accordance with claim 1 wherein said step of computing the best site ordering comprises the steps of:
for each feature site sᵢ, estimating P(Xₛᵢ=v) and N(Xₛᵢ=v) for vε{0 . . . GL-1} (GL=number of gray levels) and computing the divergence H_{P∥N}(Xₛᵢ),
for each site pair (sᵢ,sⱼ), estimating P(Xₛᵢ=v₁,Xₛⱼ=v₂), N(Xₛᵢ=v₁,Xₛⱼ=v₂), P(Xₛᵢ=v₁|Xₛⱼ=v₂), and N(Xₛᵢ=v₁|Xₛⱼ=v₂), for v₁,v₂ε{0 . . . GL-1} and computing
$${H}_{P ‖ N} ( {X}_{{s}_{i}} ‖ {X}_{{s}_{j}} ) = {\sum }_{x , y = 0}^{GL - 1} {P}_{X} ( X = x , Y = y ) ln \frac{{P}_{X} ( X = x \vert Y = y )}{{N}_{X} ( X = x \vert Y = y )} ,$$
solving a traveling salesman type problem over the sites S to find S*={s₁*, . . . , sₙ*} that maximizes H_{P∥N}(X_{S}),
computing and storing
$$L ( {X}_{{s}_{i}^{*}} = v ) = ln \frac{P ( {X}_{{s}_{i}^{*}} = v )}{N ( {X}_{{s}_{i}^{*}} = v )}$$
and
$$L ( {X}_{{s}_{i}^{*}} = {v}_{1} ‖ {X}_{{s}_{i - 1}^{*}} = {v}_{2} ) = ln \frac{P ( {X}_{{S}_{1}^{*}} = {v}_{1} ‖ {X}_{{s}_{i - 1}^{*}} = {v}_{2} )}{N ( {X}_{{s}_{i}^{*}} = {v}_{1} ‖ {X}_{{s}_{i - 1}^{*}} = {v}_{2} )} for v , {v}_{1} , {v}_{2} ∈ \{ 0 … GL - 1 \} .$$

3. An automated method for detection of an object of interest in accordance with claim 1 wherein said step of classifying said feature vector based on said best site ordering comprises:
given S*, the best Markov chain structure and the learned likelihoods L(Xₛ₁*=v) and L(Xₛᵢ*=v₁∥Xₛᵢ₋₁*=v₂) and given a test example O=(o₁, . . . oₙ), as preprocessed n-feature vector, then computing the likelihood
$${L}_{o} = L ( {X}_{{s}_{1}^{*}} = {o}_{{s}_{1}^{*}} ) + {\sum }_{i = 2}^{n} L ( {X}_{{s}_{1}^{*}} = {o}_{{s}_{1}^{*}} ‖ {X}_{{s}_{i - 1}^{*}} = {o}_{{s}_{i - 1}^{*}} ) ,$$
and if Lₒ>T then classifying O as “object of interest” else classifying it as “non object of interest”.

4. An automated method for detection of an image portion of interest of a cardiac image in magnetic resonance (MR) two-dimensional (2-D) images wherein said images comprise gray level patterns, said method including a learning stage utilizing a set of positive/negative training samples drawn from a specified feature space, said learning stage comprising the steps of:
sampling a plurality of linear cross sections through said image portion of interest and its immediate neighborhood along defined main directions;
subsampling each of said plurality of linear cross sections so as to contain a predetermined number of points;
normalizing the values of said predetermined number of points in a predefined range;
estimating the distributions of two probabilities P and N are introduced over the feature space, P being associated with positive samples including said image portion of interest and N being associated with negative samples not including said image portion of interest;
estimating parameters of Markov chains associated with all possible site permutations using said training samples;
computing the best site ordering that maximizes the Kullback distance between P and N;
computing and storing the log-likelihood ratios induced by said site ordering;
scanning a test image at different scales with a constant size window;
deriving a feature vector from results of said scanning; and
classifying said feature vector based on said best site ordering.

5. An automated method for detection of an image portion of interest in accordance with claim 4 wherein said step of computing the best site ordering comprises the steps of:
for each feature site sᵢ, estimating P(Xₛᵢ=v) and N(Xₛᵢ=v) for vε{0 . . . GL-1} (GL=number of gray levels) and computing the divergence H_{P∥N}(Xₛᵢ),
for each site pair (sᵢ,sⱼ), estimating P(Xₛᵢ=v₁,Xₛⱼ=v₂), N(Xₛᵢ=v₁,Xₛⱼ=v₂), P(Xₛᵢ=v₁|Xₛⱼ=v₂) and N(Xₛᵢ=v₁|Xₛⱼ=v₂), for v₁,v₂ε{0 . . . GL-1} and computing
$${H}_{P ‖ N} ( {X}_{{s}_{i}} ‖ {X}_{{s}_{j}} ) = {\sum }_{x , y = 0}^{GL - 1} {P}_{X} ( X = x , Y = y ) ln \frac{{P}_{X} ( X = x \vert Y = y )}{{N}_{X} ( X = x \vert Y = y )} ,$$
solving a traveling salesman type problem over the sites S to find S*={s₁*, . . . , sₙ*} that maximizes H_{P∥N}(X_{S}),
computing and storing
$$L ( {X}_{{s}_{1}^{*}} = v ) = ln \frac{P ( {X}_{{s}_{i}^{*}} = v )}{N ( {X}_{{s}_{1}^{*}} = v )} and L ( {X}_{{s}_{i}^{*}} = {v}_{1} ‖ {X}_{{s}_{i - 1}^{*}} = {v}_{2} ) = ln \frac{P ( {X}_{{s}_{i}^{*}} = {v}_{1} ‖ {X}_{{s}_{i - 1}^{*}} = {v}_{2} )}{N ( {X}_{{s}_{i}^{*}} = {v}_{1} ‖ {X}_{{s}_{i - 1}^{*}} = {v}_{2} )}$$
for v,v₁,v₂ε{0 . . . GL-1}.

6. An automated method for detection of an image portion of interest in accordance with claim 4 wherein said step of classifying said feature vector based on said best site ordering comprises:
given S*, the best Markov chain structure and the learned likelihoods L(Xₛᵢ*=v) and L(Xₛᵢ*=v₁∥Xₛᵢ₋₁*=v₂) and given a test example O=(o₁, . . . oₙ), as preprocessed n-feature vector, then computing the likelihood
$${L}_{o} = L ( {X}_{{s}_{1}^{*}} = {o}_{{s}_{1}^{*}} ) + {\sum }_{i = 2}^{n} L ( {X}_{{s}_{1}^{*}} = {o}_{{s}_{i}^{*}} ‖ {X}_{{s}_{i - 1}^{*}} = {o}_{{s}_{i - 1}^{*}} ) ,$$
and if Lₒ>T then classifying O as “image portion of interest” else classifying it as “non image portion of interest”.

7. An automated method for detection of an image of flexible objects, such as a cardiac left ventricle in a cardiac image in magnetic resonance (MR) two-dimensional (2-D) images wherein said images comprise gray level patterns, said method including a learning stage utilizing a set of positive/negative training samples drawn from a-specified feature space, said learning stage comprising the steps of:
sampling four linear cross sections through said image of said flexible object and its immediate neighborhood along defined main directions;
subsampling each of said four linear cross sections so as to contain a predetermined number of points;
normalizing the values of said predetermined number of points in a predefined range;
estimating the distributions of two probabilities P and N are introduced over the feature space, P being associated with positive samples including said image of said of said flexible object and N being associated with negative samples not including said image of said flexible object;
estimating parameters of Markov chains associated with all possible site permutations using said training samples;
computing the best site ordering that maximizes the Kullback distance between P and N;
computing and storing the log-likelihood ratios induced by said site ordering;
scanning a test image at different scales with a constant size window;
deriving a feature vector from results of said scanning; and
classifying said feature vector based on said best site ordering.

8. An automated method for detection of an image portion of interest in accordance with claim 7, wherein said step of computing the best site ordering comprises the steps of:
for each feature site sᵢ, estimating P(Xₛᵢ=v) and N(Xₛᵢ=v) for vε{0 . . . GL-1} (GL=number of gray levels) and computing the divergence H_{P∥N}(Xₛᵢ),
for each site pair (sᵢ,sⱼ), estimating P(Xₛᵢ=v₁,Xₛⱼ=v₂), N(Xₛᵢ=v₁,Xₛⱼ=v₂), P(Xₛᵢ=v₁|Xₛⱼ=v₂), and N(Xₛᵢ=v₁|Xₛⱼ=v₂), for v₁,v₂ε{0 . . . GL-1} and computing
$${H}_{P ‖ N} ( {X}_{{s}_{i}} ‖ {X}_{{s}_{j}} ) = {\sum }_{x , y = 0}^{GL - 1} {P}_{X} ( X = x , Y = y ) ln \frac{{P}_{X} ( X = x \vert Y = y )}{{N}_{X} ( X = x \vert Y = y )} ,$$
solving a traveling salesman type problem over the sites S to find S*={s₁*, . . . , sₙ*} that maximizes H_{P∥N}(X_{S}),
computing and storing
$$L ( {X}_{{s}_{1}^{*}} = v ) = ln \frac{P ( {X}_{{s}_{1}^{*}} = v )}{N ( {X}_{{s}_{1}^{*}} = v )} and L ( {X}_{{s}_{i}^{*}} = {v}_{1} ‖ {X}_{{s}_{i - 1}^{*}} = {v}_{2} ) = ln \frac{P ( {X}_{{s}_{i}^{*}} = {v}_{1} ‖ {X}_{{s}_{i - 1}^{*}} = {v}_{2} )}{N ( {X}_{{s}_{i}^{*}} = {v}_{1} ‖ {X}_{{s}_{i - 1}^{*}} = {v}_{2} )}$$
for v,v₁,v₂ε{0 . . . GL-1}.

9. An automated method for detection of an image of said flexible object in accordance with claim 4 wherein said step of classifying said feature vector based on said best site ordering comprises:
given S*, the best Markov chain structure and the learned likelihoods L(Xₛ₁*=v) and L(Xₛᵢ*=v₁|Xₛᵢ₋₁*=v₂) and given a test example O=(o₁, . . . oₙ), as preprocessed n-feature vector, then computing the likelihood
$${L}_{o } = L ( {X}_{{s}_{1}^{*}} = {o}_{{s}_{1}^{*}} ) + {\sum }_{i = 2}^{n} L ( {X}_{{s}_{i}^{*}} = {o}_{{s}_{i}^{*}} ‖ {X}_{{s}_{i - 1}^{*}} = {o}_{{s}_{i - 1}^{*}} ) ,$$
and if Lₒ>T then classifying O as “image of said flexible object” else classifying it as “non image of said flexible object”.

10. An automated method for detection of an image of said flexible object in accordance with claim 7, wherein said flexible object is a left ventricle.
